(19) United States
(12) Patent Application Publication
(10) Pub. No.: US 2017/0339594 A1
(43) Pub. Date: Nov. 23, 2017

(54) METHOD FOR TRANSMITTING MOVING CELL MEASUREMENT REPORT SIGNAL TO SERVING BASE STATION IN WIRELESS COMMUNICATION SYSTEM AND DEVICE THEREFOR

(71) Applicant: LG ELECTRONICS INC., Seoul (KR)

(72) Inventors: Kungmin PARK, Seoul (KR); Heejeong CHO, Seoul (KR); Hyunsoo KO, Seoul (KR); Hyeyoung CHOI, Seoul (KR); Ilmu BYUN, Seoul (KR)

(73) Assignee: LG ELECTRONICS INC., Seoul (KR)

(21) Appl. No.: 15/538,128

(22) PCT Filed: Dec. 22, 2014
(86) PCT No.: PCT/KR2014/012628

§ 371 Date: Jun. 20, 2017

(51) Int. Cl. H04W 24/10; H04W 88/08

(52) U.S. Cl. CPC H04W 24/10; H04W 88/08

(57) ABSTRACT

The present invention relates to a method for transmitting a moving cell measurement report signal to a serving base station in a wireless communication system and a device therefor. The method for a terminal transmitting a moving cell measurement report signal to a serving base station in a wireless communication system, according to one embodiment of the present invention, comprises the steps of: receiving, from a cell near the terminal, a cell type indicator comprising a cell identifier; determining whether the cell near the terminal is a neighboring cell within a predetermined range by using a measurement parameter according to the type of the cell identifier; and if the cell near the terminal is determined to be a neighboring cell within the predetermined range, transmitting a moving cell measurement report signal comprising the cell identifier to a serving base station.

### CROSS REFERENCE TO RELATED APPLICATIONS

This application is the National Phase of PCT International Application No. PCT/KR2014/012628, filed on Dec. 22, 2014, all of which are hereby expressly incorporated by reference into the present application.

### TECHNICAL FIELD

The present invention relates to a wireless communication system, and more particularly, to a method of transmitting a moving cell measurement report signal to a serving base station in a wireless communication system and device therefor.

### BACKGROUND ART

Recently, with the advance of wireless communication technologies, the wireless communication architecture has been changed such that various types of small cells (e.g., a pico cell, a femto cell, etc.) can be interconnected to a macro cell.

That is, to provide a higher data transfer rate to users in the situation in which the macro cell coexists with the small cells, the concept of a moving cell has been introduced in the 5G wireless communication environment. Here, the moving cell corresponds to an example of the small cell operation method, which is different from the fixed small cell considered by 3GPP (3^{rd} generation partnership project) until now.

The moving cell may mean that a cell is installed in transportation, e.g., a bus, a train, or a vehicle so that the cell can have mobility and thus provide more capacities to users or user equipments.

That is, the moving cell can be defined as a moving wireless node of a network that forms a physical cell. Due to the introduction of the moving cell, it is possible to reduce not only the cell edge effect applied to stationary users but also that applied to moving users, thereby providing extensive and various services to users.

However, in a dense heterogeneous network (HetNet) having one or more base stations, the moving cell may cause interference to a user equipment in a fixed cell.

Specifically, if the moving cell moves at a very high speed, a user equipment in the fixed cell that fails to detect the moving cell may receive interference from the moving cell. Moreover, if a highly loaded moving cell approaches the fixed cell, a plurality of user equipments in the fixed cell may receive interference from the moving cell.

Hence, it is necessary to control the interference caused to the fixed cell by the moving cell. In particular, considering that the moving cell that causes the interference to the fixed cell should be detected first in order to control the interference by the moving cell, a moving cell detection method capable of reducing loads and complexity of detection needs to be developed.

### DISCLOSURE OF THE INVENTION

### Technical Task

A technical task of the present invention is to provide a method of transmitting a moving cell measurement report signal by a user equipment to a serving base station in a wireless communication system.

Another technical task of the present invention is to provide a method of reducing loads and complexity of measurement and reporting processes of a user equipment that performs detection of a moving cell.

A further technical task of the present invention is to provide a method of reducing loads and complexity of a base station that updates a moving cell list.

Still another technical task of the present invention is to provide an apparatus for supporting the aforementioned methods.

It will be appreciated by persons skilled in the art that the objects that could be achieved with the present invention are not limited to what has been particularly described hereinabove and the above and other objects that the present invention could achieve will be more clearly understood from the following detailed description.

### Technical Solutions

To solve the aforementioned technical problem, according to one embodiment of the present invention, a method of transmitting a moving cell measurement report signal by a user equipment (UE) to a serving base station (BS) in a wireless communication system, the method comprising: receiving a cell type indicator including a cell identifier from a cell adjacent to the UE; determining whether the cell adjacent to the UE is a neighbor cell within a predetermined range by using a measurement parameter according to a cell identifier type; and transmitting the moving cell measurement report signal including the cell identifier to the serving BS when the cell adjacent to the UE is the neighbor cell within the predetermined range, wherein the cell identifier type is either a moving cell identifier or a fixed cell identifier, wherein different measurement parameters according to an identified cell identifier type is used when whether the cell adjacent to the UE is the neighbor cell within the predetermined range is determined, and wherein each of the different measurement parameters is configured with a different time to trigger (TTT) and a different measurement interval according to the cell identifier type.

To solve the aforementioned technical problem, the cell identifier included in the cell type indicator is a local identifier measured based on a reference signal of the cell adjacent to the UE.

To solve the aforementioned technical problem, identifying is based on a moving cell list including one or more moving cell identifiers in the wireless communication system.

To solve the aforementioned technical problem, each of the one or more moving cell identifiers included in the moving cell list is composed of a local identifier and a network identifier of each of one or more moving cells in the wireless communication system.

To solve the aforementioned technical problem, when the cell identifier type is the moving cell identifier, the TTT is set to be smaller than that of the fixed cell identifier.

To solve the aforementioned technical problem, the each of the different measurement parameters is received from the serving BS through radio resource control.

To solve the aforementioned technical problem, the moving cell list is transmitted by a cell management server in the wireless communication system to individual BSs in the wireless communication system besides the serving BS and a neighbor BS adjacent to the serving BS at a predetermined period and the moving cell list is received from the serving BS through radio resource control.

To solve the aforementioned technical problem, an X2 interface is established between the serving BS and the cell adjacent to the UE based on the transmitted moving cell measurement report signal and the establishment of the X2 interface is performed by the cell management server.

To solve the aforementioned technical problem, when the cell identifier included in the moving cell measurement report signal is present in the moving cell list of the serving BS, the moving cell list of the serving BS and a moving cell list of the neighbor BS are shared to inform that the cell adjacent to the UE is the neighbor cell.

To solve the aforementioned technical problem, when a moving cell measurement report signal for a moving cell identifier among one or more moving cell identifiers included in the moving cell list of the serving BS is not transmitted until expiration of a preconfigured timer of the serving BS, the moving cell identifier is deleted from the moving cell list of the serving BS.

To solve the aforementioned technical problem, according to one embodiment of the present invention, an apparatus for transmitting a moving cell measurement report signal to a serving base station (BS) in a wireless communication system, the apparatus comprising: a radio frequency (RF) unit configured to include a transmitter and a receiver; and a processor connected to the transmitter and the receiver to support communication of the apparatus, wherein the processor is configured to receive a cell type indicator including a cell identifier from a cell adjacent to the apparatus, determine whether the cell adjacent to the apparatus is a neighbor cell within a predetermined range by using a measurement parameter according to a cell identifier type, transmit the moving cell measurement report signal including the cell identifier to the serving BS when the cell adjacent to the UE is the neighbor cell within the predetermined range, wherein the cell identifier type is either a moving cell identifier or a fixed cell identifier, wherein different measurement parameters according to an identified cell identifier type is used when whether the cell adjacent to the UE is the neighbor cell within the predetermined range is determined, and wherein each of the different measurement parameters is configured with a different time to trigger (TTT) and a different measurement interval according to the cell identifier type.

To solve the aforementioned technical problem, the cell identifier included in the cell type indicator is a local identifier measured based on a reference signal of the cell adjacent to the apparatus.

To solve the aforementioned technical problem, the processor is configured to identify the cell identifier type of the cell adjacent to the apparatus based on a moving cell list including one or more moving cell identifiers in the wireless communication system.

To solve the aforementioned technical problem, each of the one or more moving cell identifiers included in the moving cell list is composed of a local identifier and a network identifier of each of one or more moving cells in the wireless communication system.

To solve the aforementioned technical problem, when the cell identifier type is the moving cell identifier, the TTT is set to be smaller than that of the fixed cell identifier.

To solve the aforementioned technical problem, the each of the different measurement parameters is received from the serving BS through radio resource control.

To solve the aforementioned technical problem, the moving cell list is transmitted by a cell management server in the wireless communication system to individual BSs in the wireless communication system besides the serving BS and a neighbor BS adjacent to the serving BS at a predetermined period and the moving cell list is received from the serving BS through radio resource control.

To solve the aforementioned technical problem, an X2 interface is established between the serving BS and the cell adjacent to the apparatus based on the transmitted moving cell measurement report signal and the establishment of the X2 interface is performed by the cell management server.

To solve the aforementioned technical problem, when the cell identifier included in the moving cell measurement report signal is present in the moving cell list of the serving BS, the moving cell list of the serving BS and a moving cell list of the neighbor BS are shared to inform that the cell adjacent to the apparatus is the neighbor cell.

To solve the aforementioned technical problem, when a moving cell measurement report signal for a moving cell identifier among one or more moving cell identifiers included in the moving cell list of the serving BS is not transmitted until expiration of a preconfigured timer of the serving BS, the moving cell identifier is deleted from the moving cell list of the serving BS.

### Advantageous Effects

According to embodiments of the present invention, a method of transmitting a moving cell measurement report signal by a user equipment to a serving base station in a wireless communication system can be provided.

According to embodiments of the present invention, it is possible to reduce loads and complexity of measurement and reporting processes of a user equipment that performs detection of a moving cell.

According to embodiments of the present invention, it is possible to reduce loads and complexity of a base station that updates a list of moving cells.

It will be appreciated by persons skilled in the art that the effects that can be achieved through the present invention are not limited to what has been particularly described hereinabove and other advantages of the present invention will be more clearly understood from the following detailed description.

### DESCRIPTION OF DRAWINGS

The accompanying drawings, which are included to provide a further understanding of the invention and are incorporated in and constitute a part of this specification, illustrate embodiments of the invention and together with the description serve to explain the principles of the invention.

FIG. 1 is a diagram illustrating an example of a general wireless communication system to which the present invention is applicable.

FIG. 2 illustrates a structure of an evolved universal terrestrial radio access network (E-UTRAN) to which the present invention is applicable.

FIG. 3 is a diagram for explaining a concept of an autonomous neighbor relation (ANR) algorithm for detection of a neighbor moving cell to which the present invention is applicable.

FIG. 4 is a diagram for explaining a concept of a moving cell detection time that can be applied according to a movement speed of a user equipment.

FIG. 5 is a diagram for explaining a concept of a moving cell detection time that can be applied according to a movement speed of a moving cell.

FIG. 6 is a diagram illustrating a method of transmitting a moving cell measurement report signal by a user equipment to a serving base station in a wireless communication system according to an embodiment of the present invention.

FIG. 7 is a diagram illustrating an apparatus for transmitting a moving cell measurement report signal to a serving base station in a wireless communication system according to an embodiment of the present invention.

### BEST MODE FOR INVENTION

Hereinafter, the preferred embodiments of the present invention will be described with reference to the accompanying drawings. It is to be understood that the detailed description, which will be disclosed along with the accompanying drawings, is intended to describe the exemplary embodiments of the present invention, and is not intended to describe a unique embodiment with which the present invention can be carried out.

The following detailed description includes detailed matters to provide full understanding of the present invention. However, it will be apparent to those skilled in the art that the present invention can be carried out without the detailed matters.

In some cases, to prevent the concept of the present invention from being ambiguous, structures and apparatuses of the known art will be omitted, or will be shown in the form of a block diagram based on main functions of each structure and apparatus.

In the specification, when a part “comprises” or “includes” an element, it means that the part further comprises or includes another element unless otherwise mentioned.

Also, the term “ . . . module” disclosed in the specification means a unit for processing at least one function or operation, and may be implemented by hardware, software or combination of hardware and software. Moreover, it is to be understood that the singular expression “a” (or “an”), “one” and “a related similar word” used in this specification includes the plural expression unless defined differently on the context of the present invention.

Specific terms used in the embodiments of the present invention are provided to assist understanding of the present invention, and all terms used herein including technical or scientific terms have the same meaning as those generally understood by the person with ordinary skill in the art to which the present invention pertains. Various modifications may be made in the specific terms within the range that they do not depart from technical spirits of the present invention.

Although the terms such as “first” and/or “second” in this specification may be used to describe various elements, it is to be understood that the elements are not limited by such terms. The terms may be used to identify one element from another element. For example, a first element may be referred to as a second element, and vice versa within the range that does not depart from the scope of the present invention.

Hereinafter, the preferred embodiments of the present invention will be described with reference to the accompanying drawings. It is to be understood that the detailed description, which will be disclosed along with the accompanying drawings, is intended to describe the exemplary embodiments of the present invention, and is not intended to describe a unique embodiment with which the present invention can be carried out.

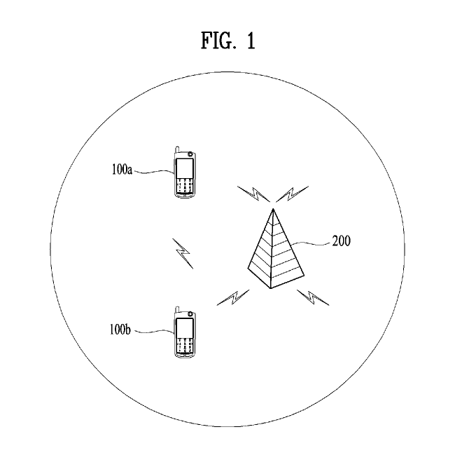

FIG. 1 is a diagram illustrating an example of a general wireless communication system to which the present invention is applicable.

Referring to FIG. 1, a wireless communication system may include user equipments (UEs) 100a and 100b and a base station (BS) 200. Although FIG. 1 shows only one BS, it should be noted that one or more BSs and/or one or more UEs can be included in the wireless communication system.

In this specification, a UE can be used as a generic term for a mobile or fixed user-end device such as a terminal, a mobile station (MS), a mobile subscriber station (MSS), a subscriber station (SS), an advanced mobile station (AMS), a wireless terminal (WT), a machine-type communication (MTC) device, a machine-to-machine (M2M) device, a device-to-device (D2D) device, etc.

In addition, a BS may mean a terminal node of a network directly communicating with the UEs 100a and 100b and replaced with a fixed station, a Node B, an eNode B (eNB), etc.

In the present invention, the BS 200 may be connected to the UEs 100a and 100b for direct communication. Here, the connection between the UEs 100a and 100b and the BS 200 may mean that the UEs 100a and 100b and the BS 200 can transmit and receive messages or information requests and responses with each other. In addition, all wireless communication devices that use radio waves or infrared rays can be used as a connection means between the UEs 100a and 100b and the BS 200.

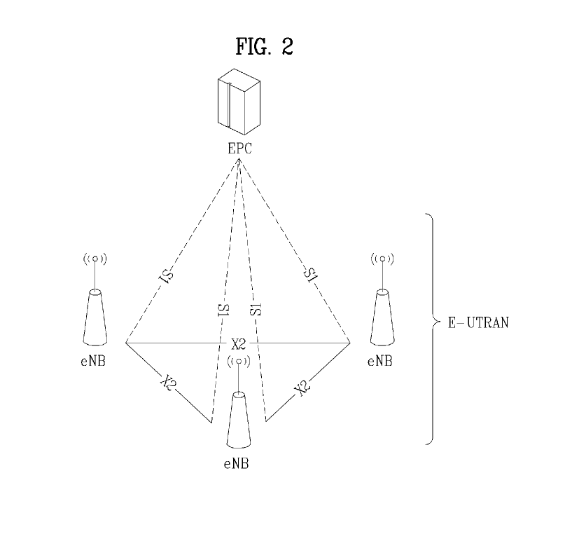

FIG. 2 illustrates a structure of an evolved universal terrestrial radio access network (E-UTRAN) to which the present invention is applicable.

The E-UTRAN system of FIG. 2 is an evolved version of the conventional UTRAN system. The E-UTRAN system includes one or more eNBs and the eNBs are connected to each other through an X2 interface.

An X2 user-plane (X2-U) interface is defined between eNBs and provides non-guaranteed delivery of a user-plane PDU. An X2 control-plane (X2-CP) interface is defined between two neighbor eNBs.

The X2-CP interface is used for context exchange between eNBs, user-plane tunnel control between a source eNB and a target eNB, handover related message exchange, uplink load management, etc. An eNB is connected to a UE through a radio interface and connected to an evolved packet core (EPC) through an S1 interface.

Meanwhile, an S1 user-plane (S1-U) interface is defined between an eNB and a serving gateway (S-GW) and an S1 control-plane (S1-MME) interface is defined between an eNB and a mobility management entity (MME).

The S1 interface is used for evolved packet system (EPS) bearer service management, non-access stratum (NAS) signaling transport, network sharing, MME load balancing, etc.

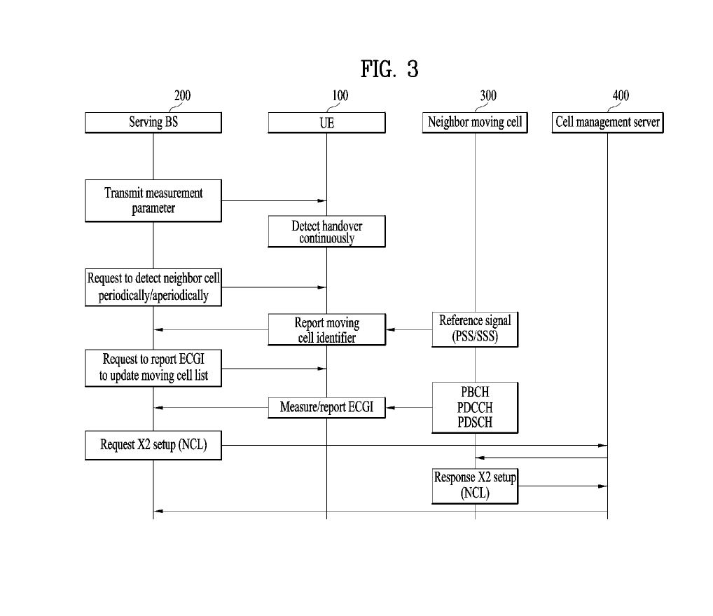

FIG. 3 is a diagram for explaining a concept of an autonomous neighbor relation (ANR) algorithm for detection of a neighbor moving cell to which the present invention is applicable.

Referring to FIG. 3, a wireless communication system to which the ANR algorithm for detection of a neighbor moving cell can be applied may include a UE 100, a serving BS 200 connected to the UE 100, a moving cell 300 adjacent to the UE 100, and a cell management server 400 that manages cells in the wireless communication system.

The ANR algorithm for detecting the neighbor moving cell of FIG. 3 means a self-organizing networks (SON) scheme. That is, according to the SON scheme, the UE 100 reports a cell identifier (e.g., a physical cell identifier (PCID) or an E-UTRAN cell global identifier (ECGI)) of the moving cell 300 adjacent to the UE 100 to the serving BS 200 and the serving BS 200 configures an X2 interface with the reported moving cell 300, which is adjacent to the UE 100.

In this case, the serving BS 200 may allocate a measurement time for detecting a neighbor cell (hereinafter referred to as a time to trigger (TTT)) for the UE 100 through radio resource control (RRC) (in this case, the TTT is in the range of 0 to 5120 ms). In addition, the UE 100 may adjust the TTT range according to mobility. That is, the UE 100 may adjust a scale of the TTT.

The SON scheme may mean a scheme in which each BS establishes a network configuration or performs network optimization by recognizing its own surrounding environment without a central coordinator. In addition, according to the SON scheme, individual BSs transmit or receive necessary information and the necessary configuration or optimization may be performed based on a distribution algorithm.

Meanwhile, although not shown in FIG. 3, the serving BS 200 may receive a neighbor cell list from the cell management server 400 and then continuously mange a list of neighbor cells that could be handed over based on the received neighbor cell list.

In addition, the serving BS 200 may support handover by establishing an X2 interface with a BS corresponding to a neighbor cell and control inter-cell interference by sharing necessary control information or channel information.

Referring back to FIG. 3, the serving BS 200 with the neighbor cell list may transmit a measurement parameter necessary for the UE 100 to detect a neighbor cell to the UE 100. Thereafter, the UE 100 may detect a cell adjacent to the UE 100 based on the received measurement parameter.

In this case, the UE 100 may receive the measurement parameter through the RRC and the measurement parameter may include the TTT (from 0 to 5120 ms). In addition, the UE 100 may adjust the range of the TTT according to its mobility.

Thereafter, the serving BS 200 may request the UE 100 to detect the neighbor cell periodically or aperiodically by measuring a reference signal received power (RSRP). In this case, the neighbor cell detection request may include the neighbor cell list.

From the perspective of the serving BS 200, the neighbor cell detection request is to update the neighbor cell list by detecting a new neighbor cell that is not registered in the neighbor cell list.

After receiving the neighbor cell detection request based on the RSRP measurement from the serving BS 200, the UE 100 may measure the RSRP according to the following three methods.

As a first method, the UE 100 may periodically measure the RSRP for a band indicated by the service BS 200 or the neighbor cell list. When determining that the RSRP of a neighbor cell is greater than a predetermined threshold value during a prescribed time (e.g., TTT), the UE 100 may transmit a cell identifier (e.g., PCI, etc.) of the neighbor cell to the serving BS 200.

As a second method, the UE 100 measures the RSRP of the neighbor cell in the same manner as described above. However, when a difference between the RSRP of a neighbor cell and the RSRP of the serving BS 200 is greater than the predetermined threshold value during the prescribed time (e.g., TTT), the UE 100 may transmit a cell identifier (e.g., PCI, etc.) to the serving BS 200.

As a third method, the serving BS 200 may request all the UEs in its cell to periodically perform measurement according to the aforementioned first and second methods and then report the measurement results.

Meanwhile, after obtaining the cell identifier (e.g., PCI or local ID) of the neighbor moving cell 300 based on a reference signal of the neighbor moving cell 300, the UE 100 may report the cell identifier of the neighbor moving cell 300 to the serving BS 200.

After receiving the cell identifier of the neighbor moving cell 300 from the UE 100, the serving BS 200 determines whether the cell identifier of the neighbor moving cell 300 is included in its neighbor cell list. When the cell identifier of the neighbor moving cell 300 is a new cell identifier, which is not included in the neighbor cell list, the serving BS 200 may request the UE 100 to report an E-UTRAN cell global identifier (ECGI) of the neighbor moving cell 300 by decoding a physical broadcast channel of the neighbor moving cell 3

After receiving the request for reporting the ECGI of the neighbor moving cell 300 from the serving BS 200, the UE 100 may check the ECGI by decoding the PBCH of the neighbor moving cell 300 and then report the ECGI to the serving BS 200.

After receiving the ECGI of the neighbor moving cell 300 from the UE 100, the serving BS 200 may update the neighbor cell list using the cell identifier (e.g., PCI, etc.) and the ECGI of the neighbor moving cell 300 in order to add the neighbor moving cell 300 to its neighbor cell list. Thereafter, the serving BS 200 may transmit a message requesting the cell management server 400 to establish an X2 interface with the neighbor moving cell 300. In this case, the neighbor cell list of the serving BS 200 may be transmitted together.

The cell management server 400 may forward the message requesting to establish the X2 interface, which is transmitted from the serving BS 200, to the neighbor moving cell 300. After receiving the message from the cell management server 400, the neighbor moving cell 300 may transmit an X2 interface establishment response message to the cell management server 400 in response to the X2 interface establishment request message in order to establish the X2 interface. After receiving the X2 interface establishment response message from the cell management server 400, the serving BS 200 may establish the X2 interface with the neighbor moving cell 300. In this case, the X2 interface establishment response message may be transmitted together with a neighbor cell list of the neighbor moving cell 300.

The serving BS 200 may continuously update its neighbor cell list based on the aforementioned ANR algorithm and continuously manage interference from neighbor moving cells based on the updated neighbor cell list.

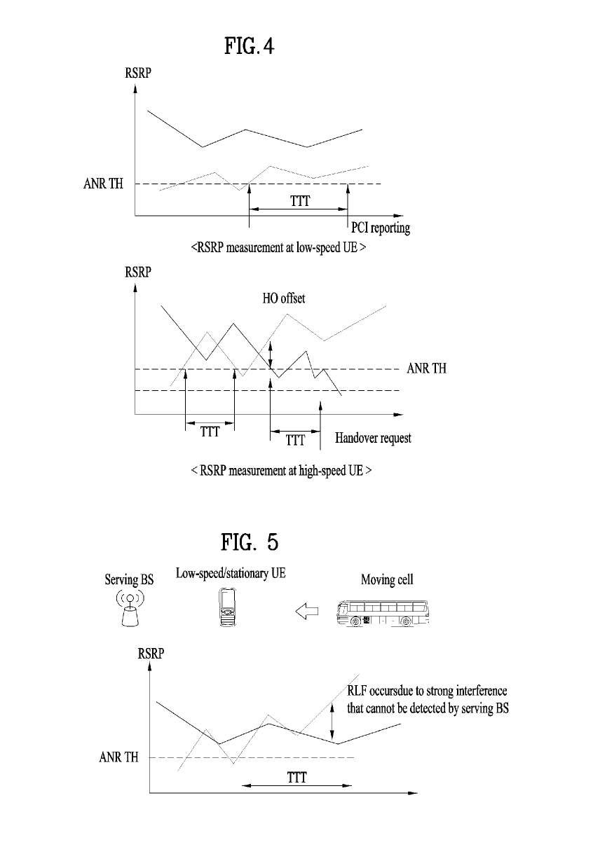

FIG. 4 is a diagram for explaining a concept of a moving cell detection time that can be applied according to a movement speed of a user equipment.

Specifically, FIG. 4 shows a method for determining a measurement time (TTT) value for RSRP measurement with reference to a UE's movement speed. More specifically, the first drawing shows a TTT value when a low-speed UE measures an RSRP and the second drawing shows a TTT value when a high-speed UE measures an RSRP. In addition, it can be seen that the former TTT value is different from the later TTT value.

In the case of the low-speed UE, since the low-speed UE slowly approaches a neighbor cell with a value less than a predetermined threshold value (TH) due to its low speed, the value of the neighbor cell may become greater than the predetermined TH.

In this case, assuming that the UE sets a large TTT value for measuring an RSRP of the neighbor cell, only when the RSRP of the neighbor cell is maintained as the predetermined TH during the large TTT value, the UE can report a cell identifier of the neighbor cell to a serving BS. That is, the UE may perform neighbor cell detection with high reliability.

On the other hand, in the case of the high-speed UE, since the high-speed UE rapidly approaches a neighbor cell with a value less than a predetermined threshold value (TH) due to its high speed, the value of the neighbor cell may become greater than the predetermined TH.

In this case, assuming that the UE sets a small TTT value for measuring an RSRP of the neighbor cell, even when the RSRP of the neighbor cell is maintained as the predetermined TH during the small TTT value, the UE can report a cell identifier of the neighbor cell to a serving BS. Therefore, neighbor cell detection can be rapidly performed before radio link failure (RLF) and thus handover can also be performed rapidly.

FIG. 5 is a diagram for explaining a concept of a moving cell detection time that can be applied according to a movement speed of a moving cell.

Unlike FIG. 4 where a UE moves at a low or high speed, FIG. 5 shows the concept of the moving cell detection time when a cell adjacent to a UE moves, i.e., a moving cell approaches a UE.

As described above, the moving cell means that a cell is installed in transportation, e.g., a bus, a train, or a vehicle so that the cell can have mobility and thus provide more capacities to users or user equipments. In FIG. 5, it is assumed that a moving cell, which is installed in a bus to provide capacities to UEs, approaches a UE that moves at a low speed or being in a stationary state.

In this case, from the perspective of the UE, an RSRP of the moving cell approaching the UE may be increased rapidly.

If a TTT value for RSRP measurement is determined based on a UE's movement speed as described with reference to FIG. 4, the TTT value needs to be large because the UE moves at the low speed or is in the stationary state. However, considering that the RSRP of the moving cell is rapidly increased but the RSRP does not exceed a threshold value during the determined TTT value, reporting of a moving cell identifier to a serving BS could be delayed.

That is, the RLF may occur before the UE completes measurement of the moving cell's RSRP. In this case, the UE cannot transmit the cell identifier of the moving cell to the serving BS and thus, the serving BS, i.e., a fixed cell cannot recognize that the moving cell is a neighbor cell.

In other words, if a UE measures a neighbor cell or a moving cell based on mobility of the UE as described in FIG. 4, mobility of the moving cell could not be reflected and thus, it may cause such a serious problem that the UE fails to detect the moving cell.

In order to solve these problems, the present invention proposes a method of transmitting a moving cell measurement report signal and details of the method will be described hereinafter.

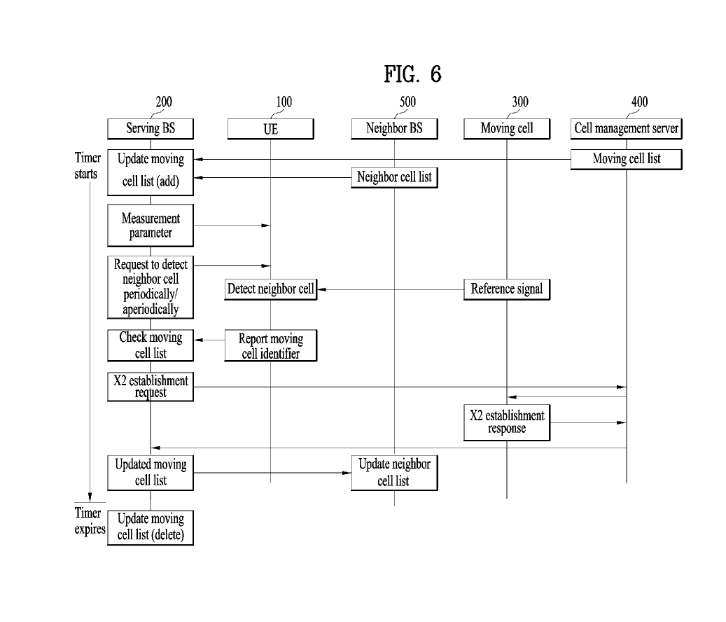

FIG. 6 is a diagram illustrating a method of transmitting a moving cell measurement report signal by a user equipment to a serving base station in a wireless communication system according to an embodiment of the present invention.

Referring to FIG. 6, a wireless communication system to which the present invention can be applied may include a UE 100, a serving BS 200 connected to the UE 100, a moving cell 300 adjacent to the UE, which is not detected yet, a cell management server 400 that manages cells in the wireless communication system, and a neighbor cell 500 adjacent to the UE, which is already detected.

According to a method of transmitting a moving cell measurement report signal by a UE to a serving BS in a wireless communication system described in FIG. 6, a UE may receive a cell identifier (e.g., PCI or local ID) of a neighbor cell while measuring the neighbor cell, determine whether the neighbor cell is a fixed cell or a moving cell based on the cell identifier, and then apply a different TTI value according to the determination result in order to measure the neighbor cell.

To this end, it is assumed in the present invention that a different type of cell identifier is allocated to a moving cell and a fixed cell. In addition, it is also assumed that the moving cell 300 broadcasts a reference signal containing a cell type indicator and the UE 100 receives the broadcasted reference signal to identify a cell type of the moving cell 300 (whether the moving cell 300 is a moving cell or a fixed cell). Particularly, it is assumed that the serving BS 200 informs the UE 100 of the cell identifier (e.g., PCI or local ID) of the moving cell 300 through RRC in advance.

Referring back to FIG. 6, the serving BS 200 may receive a moving cell list from the cell management server 400 and continuously manage a neighbor cell list based on the received moving cell list.

In this case, the cell management server 400 may correspond to a mobility management entity (MME) that manages handover between a plurality of cells or relationships between the cells. The cell management server 400 may create the moving cell list by including identifiers of moving cells controlled by the cell management server 400 and then transmit the moving cell list to all cells managed by the cell management server 400, i.e., all BSs included in the wireless communication system.

Here, the moving cell list contains cell identifiers (PCIS or local IDs) and ECGIs of all individual moving cells. In addition, the cell management server 400 may update the moving cell list at a prescribed period and then transmit the moving cell list to all the cells managed by the cell management server 400.

After receiving the moving cell list from the cell management server 400, the serving BS 200 may receive a moving cell list of the detected neighbor cell 500 (hereinafter referred to as a neighbor cell list) from the detected neighbor cell 500. Thereafter, the serving BS 200 may perform an update to include a cell, which is included in the neighbor cell list but not included in its moving cell list, in its moving cell list.

In other words, the update may be called cell-specific operation. By doing so, even though individual cells receive the same moving cell list from the cell management server 400, the individual cells may have different moving cell lists.

Referring back to FIG. 6, the serving BS 200 having the moving cell list can transmit measurement parameter necessary to measure or detect a neighbor cell to the UE 100 through RRC together with a neighbor cell detection request.

In this case, the measurement parameter can be independently defined for each measuring cell such that one parameter set is used by one cell. In addition, when measurement parameter sets are defined as set 0, set 1, set 2, and the like, the number of parameters included in each set may be different from each other. Moreover, if an undefined parameter value is required in a specific set, a parameter value defined in a basic parameter set (e.g., set 0) can be used as it is.

According to an embodiment of the present invention, the measurement parameter can include at least one parameter configured with a different measurement time (TTT) and a different measurement interval according to the cell identifier type (whether a cell is a fixed cell or a moving cell). In this case, when the cell identifier type is a moving cell identifier, the TTT may be set to be smaller than that of a fixed cell identifier. As described above, this is because in the case of the moving cell, detection should be performed during a small TTT to prevent the RLF from occurring.

The measurement parameter can be transmitted together the moving cell list of the serving BS 200.

Meanwhile, after receiving the neighbor cell detection request including the measurement parameter, the UE 100 performs neighbor cell detection and may obtain a cell type indicator including the cell identifier (e.g., PCI or local ID) of the moving cell 300 from the reference signal broadcasted by the moving cell 300 adjacent to the UE 100.

After receiving the cell type indicator including the cell identifier of the moving cell 300, the UE 100 may confirm a cell type of the moving cell by comparing the cell identifier of the moving cell 300 with the moving cell list of the serving BS 200 transmitted from the serving BS 200. When confirming that the cell type of the moving cell 300 is the moving cell, the UE 100 performs the cell detection using a moving cell measurement parameter included in the received measurement parameter.

When the UE 100 determines that the moving cell 300 is a neighbor cell within a predetermined range (e.g., a case in which the RSRP is equal to or higher than the threshold value during the TTT or a case in which a difference between the RSRP and the RSRP of the serving BS is equal to or higher than the threshold value during the TTT), the UE 100 may transmit a moving cell measurement report signal including the cell identifier of the moving cell 300 to the serving BS 200.

In this case, according to an embodiment of the present invention, since the serving BS 200 receives the moving cell list containing the cell identifiers (PCIs) and the ECGIs of all cells existing in the wireless communication system from the cell management server 400, the UE 100 can transmit the cell identifier (PCI) of the moving cell 300 only. That is, the UE 100 can drop a process for reporting an ECGI of the moving cell 300 by separately decoding a PBCH and the like, thereby reducing loads.

In addition, although not shown in FIG. 6, the UE 100 may simultaneously report measurement results of at least one moving cells including the moving cell 300 based on the moving cell list and the measurement parameter.

After receiving the moving cell measurement report signal including the cell identifier of the moving cell 300, the serving BS 200 may confirm the ECGI of the moving cell 300 by comparing the cell identifier of the moving cell 300 with its moving cell list and then transmit a message requesting the cell management server 400 to establish an X2 interface with the moving cell 300.

The cell management server 400 may forward the message requesting to establish the X2 interface, which is transmitted from the serving BS 200, to the moving cell 300. After receiving the X2 interface establishment request message from the cell management server 400, the moving cell 300 may transmit an X2 interface establishment response message to the cell management server 400 in order to establish the X2 interface. After receiving the X2 interface establishment response message from the cell management server 400, the serving BS 200 may establish the X2 interface with the moving cell 300. In other words, the X2 interface between the serving BS 200 and the moving cell 300 can be established through the cell management server 400.

In addition, after the X2 interface establishment, the serving BS 200 may share cell information with the neighbor BS 500 by transmitting its moving cell list to the neighbor BS 500.

Further, as shown in FIG. 6, the serving BS 200 may separately include a timer therein. When receiving the moving cell list from the cell management server 400, the serving BS 200 may be configured to start the inner timer.

If the UE 100 fails to detect at least one moving cell included in the moving cell list until expiration of the inner timer, the serving BS 200 may not receive a moving cell measurement report signal with respect to the at least one moving cell. In this case, the serving BS 200 may perform an update to delete a cell identifier of the at least one moving cell from the moving cell list.

In addition, after performing the update for deleting the cell identifier of the at least one moving cell, the serving BS 200 may transmit the updated moving cell list to the UE 100. Thereafter, the UE 100 may perform the procedure for transmitting the moving cell measurement report signal as described above based on the updated moving cell list. That is, it has an advantage of reducing measurement complexity and loads of the UE 100.

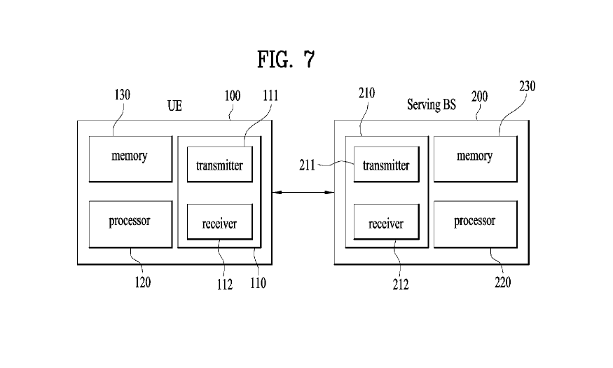

FIG. 7 is a diagram illustrating an apparatus for transmitting a moving cell measurement report signal to a serving base station in a wireless communication system according to an embodiment of the present invention.

Although FIG. 7 shows one to one communication environment between a UE 100 and a serving BS 200, communication environment can be established between a plurality of UEs and a BS.

In addition, it is assumed that the components illustrated in FIG. 7 include the UEs and the serving BSs mentioned with reference to FIGS. 1 to 6.

Referring to FIG. 7, the serving BS 200 may include a radio frequency (RF) unit 210, a processor 220 and a memory 230.

Overall communication processes of the serving BS 200 including signal processing, layer processing and the like are controlled by the processor 220 and the memory 230. Moreover, connection relations may be formed between the RF unit 210, the processor 220 and the memory 230.

The RF unit 210 included in the serving BS 200 may include a transmitter 211 and a receiver 212. The transmitter 211 and the receiver 212 may be configured to transmit and receive signals to and from the UE 100 or other BSs.

The processor 220 is functionally connected to the transmitter 211 and the receiver 212 in the RF unit 210 and may be configured to control processes for the transmitter 211 and the receiver 212 to transmit and receive the signals to and from the UE 100 and other BSs. In addition, the processor 220 performs various processing on a signal to be transmitted and then transmits the signal to the transmitter 211. Moreover, the processor 220 may perform various processing on a signal received through the receiver 212.

If necessary, the processor 220 can save information included in an exchanged message in the memory 230. Based on the aforementioned structure, the serving BS 200 may perform the methods described with reference to the various embodiments of the present invention.

The UE 100 may include an RF unit 110 including a transmitter 111 and a receiver 112 and the RF unit 110 may be configured to transmit and receive signals to and from the serving BS 200.

The processor 120 of the UE 100 is functionally connected to the transmitter 111 and the receiver 112 and may be configured to control processes for the transmitter 111 and the receiver 112 to transmit and receive the signals to and from other devices including the serving BS 200.

In addition, the processor 120 may perform various processing on a signal to be transmitted and then transmits the signal to the transmitter 111. Moreover, the processor 120 may perform various processing on a signal received through the receiver 112.

If necessary, the processor 120 can save information included in an exchanged message in a memory 130.

The processor 120 of the UE 100 instructs (e.g., controls, adjusts, manages, etc.) operations of the UE 100. In addition, the processor 220 of the serving BS 200 instructs (e.g., controls, adjusts, manages, etc.) operations of the serving BS 200. The processor 120/220 may be connected to the memory 130/230 capable of storing program codes and data. The memory 130/230 may store an operating system, an application and general files in a manner of being connected to the processor 120/220.

The processor 120/220 of the present invention may be referred to as a controller, a microcontroller, a microprocessor, a microcomputer or the like. Meanwhile, the processor 120/220 may be implemented using hardware, firmware, software and/or any combinations thereof.

In case of the implementation by firmware or software, an embodiment of the present invention may be implemented by modules, procedures, and/or functions for performing the above-explained functions or operations. Software code may be stored in the memory 130/230 and driven by the processor 120/220. The memory 130/230 may be provided within or outside the UE 100/the serving BS 200 to exchange data with the processor 120/220 through the various means known to the public.

In case of the implementation using hardware, at least one of ASICs (application specific integrated circuits), DSPs (digital signal processors), DSPDs (digital signal processing devices), PLDs (programmable logic devices), FPGAs (field programmable gate arrays) and the like may be installed in the processor 120/220.

Meanwhile, the aforementioned method can be written as computer programs and can be implemented in general-use digital computers that execute the programs using a computer readable recording medium. In addition, a data structure used for the aforementioned method can be recorded by various means in a computer-readable media. Program storing devices usable for explaining a storing device, which includes an executable computer code configured to perform various methods of the present invention, should not be understood as a device including such temporary objects as carrier waves and signals. The computer-readable media includes such a storing media as a magnetic storing media (e.g., a ROM, a floppy disk, a hard disk and the like) and an optical reading media (e.g., a CD-ROM, a DVD and the like).

While the present invention has been described and illustrated herein with reference to the preferred embodiments thereof, it will be apparent to those skilled in the art that various modifications and variations can be made therein without departing from the spirit and scope of the invention. Thus, it is intended that the present invention covers the modifications and variations of this invention that come within the scope of the appended claims and their equivalents.

### INDUSTRIAL APPLICABILITY

A method of transmitting a moving cell measurement report signal to a serving base station in a wireless communication system according to the present invention can be applied to various systems and devices for transmitting the moving cell measurement report signal.

1. A method of transmitting a moving cell measurement report signal by a user equipment (UE) to a serving base station (BS) in a wireless communication system, the method comprising:
receiving a cell type indicator including a cell identifier from a cell adjacent to the UE;
determining whether the cell adjacent to the UE is a neighbor cell within a predetermined range by using a measurement parameter according to a cell identifier type; and
transmitting the moving cell measurement report signal including the cell identifier to the serving BS when the cell adjacent to the UE is the neighbor cell within the predetermined range,
wherein the cell identifier type is either a moving cell identifier or a fixed cell identifier,
wherein different measurement parameters according to an identified cell identifier type is used when whether the cell adjacent to the UE is the neighbor cell within the predetermined range is determined, and
wherein each of the different measurement parameters is configured with a different time to trigger (TTT) and a different measurement interval according to the cell identifier type.

2. The method of claim 1, wherein the cell identifier included in the cell type indicator is a local identifier measured based on a reference signal of the cell adjacent to the UE.

3. (canceled)

4. The method of claim 1, wherein the cell identifier type is identified based on a moving cell list including one or more moving cell identifiers in the wireless communication system, and
wherein each of the one or more moving cell identifiers included in the moving cell list is composed of a local identifier and a network identifier of each of one or more moving cells in the wireless communication system.

5. The method of claim 1, wherein when the cell identifier type is the moving cell identifier, the TTT is set to be smaller than that of the fixed cell identifier.

6. The method of claim 1, wherein the each of the different measurement parameters is received from the serving BS through radio resource control.

7. The method of claim 4, wherein the moving cell list is transmitted by a cell management server in the wireless communication system to individual BSs in the wireless communication system besides the serving BS and a neighbor BS adjacent to the serving BS at a predetermined period and wherein the moving cell list is received from the serving BS through radio resource control.

8. The method of claim 7, wherein an X2 interface is established between the serving BS and the cell adjacent to the UE based on the transmitted moving cell measurement report signal and wherein the establishment of the X2 interface is performed by the cell management server.

9. The method of claim 7, wherein when the cell identifier included in the moving cell measurement report signal is present in the moving cell list of the serving BS, the moving cell list of the serving BS and a moving cell list of the neighbor BS are shared to inform that the cell adjacent to the UE is the neighbor cell.

10. The method of claim 9, wherein when a moving cell measurement report signal for a moving cell identifier among one or more moving cell identifiers included in the moving cell list of the serving BS is not transmitted until expiration of a preconfigured timer of the serving BS, the moving cell identifier is deleted from the moving cell list of the serving BS.

11. An apparatus for transmitting a moving cell measurement report signal to a serving base station (BS) in a wireless communication system, the apparatus comprising:
a radio frequency (RF) unit configured to include a transmitter and a receiver; and
a processor connected to the transmitter and the receiver to support communication of the apparatus,
wherein the processor is configured to:
receive a cell type indicator including a cell identifier from a cell adjacent to the apparatus,
determine whether the cell adjacent to the apparatus is a neighbor cell within a predetermined range by using a measurement parameter according to a cell identifier type, and
transmit the moving cell measurement report signal including the cell identifier to the serving BS when the cell adjacent to the UE is the neighbor cell within the predetermined range,
wherein the cell identifier type is either a moving cell identifier or a fixed cell identifier,
wherein different measurement parameters according to an identified cell identifier type is used when whether the cell adjacent to the UE is the neighbor cell within the predetermined range is determined, and
wherein each of the different measurement parameters is configured with a different time to trigger (TTT) and a different measurement interval according to the cell identifier type.

12. The apparatus of claim 11, wherein the cell identifier included in the cell type indicator is a local identifier measured based on a reference signal of the cell adjacent to the apparatus.

13. (canceled)

14. The apparatus of claim 11, wherein the processor is configured to identify the cell identifier type of the cell adjacent to the apparatus based on a moving cell list including one or more moving cell identifiers in the wireless communication system, and
wherein each of the one or more moving cell identifiers included in the moving cell list is composed of a local identifier and a network identifier of each of one or more moving cells in the wireless communication system.

15. The apparatus of claim 11, wherein when the cell identifier type is the moving cell identifier, the TTT is set to be smaller than that of the fixed cell identifier.

16. The apparatus of claim 11, wherein the each of the different measurement parameters is received from the serving BS through radio resource control.

17. The apparatus of claim 14, wherein the moving cell list is transmitted by a cell management server in the wireless communication system to individual BSs in the wireless communication system besides the serving BS and a neighbor BS adjacent to the serving BS at a predetermined period and wherein the moving cell list is received from the serving BS through radio resource control.

18. The apparatus of claim 17, wherein an X2 interface is established between the serving BS and the cell adjacent to the apparatus based on the transmitted moving cell measurement report signal and wherein the establishment of the X2 interface is performed by the cell management server.

19. The apparatus of claim 17, wherein when the cell identifier included in the moving cell measurement report signal is present in the moving cell list of the serving BS, the moving cell list of the serving BS and a moving cell list of the neighbor BS are shared to inform that the cell adjacent to the apparatus is the neighbor cell.

20. The apparatus of claim 19, wherein when a moving cell measurement report signal for a moving cell identifier among one or more moving cell identifiers included in the moving cell list of the serving BS is not transmitted until expiration of a preconfigured timer of the serving BS, the moving cell identifier is deleted from the moving cell list of the serving BS.
